(19) United States
(12) Patent Application Publication
(10) Pub. No.: US 2004/0021341 A1
(43) Pub. Date: Feb. 5, 2004

(54) Method for production of a vehicle door and a frameless door made by the said method

(76) Inventor: Erich Zimmer, Wadern (DE)

Correspondence Address: McGlew and Tuttle, Scarborough Station, Scarborough, NY, 10510-0827, US

(21) Appl. No.: 10/343,176

(22) PCT Filed: Jul. 5, 2001
(86) PCT No.: PCT/EP01/07702

(30) Foreign Application Priority Data
Jul. 28, 2000 (DE) 100 37 303.8

(51) Int. Cl. B60J 5/04

(52) U.S. Cl. 296/146.5

(57) ABSTRACT

A method for production of a door for a motor vehicle is provided for at least one door inner piece (1) and at least one door outer sheet (2), which are produced separately from each other and are then combined into one. The method includes making the door inner piece entirely or partially of cast aluminum. The door outer sheet is made of aluminum. The edge (13) of the door outer sheet (2) is folded towards the door inner piece (1). The folded edge (13) of the door outer sheet (2) is brought into contact with a mating surface (12) of the outer edge (11) of the door inner piece (1). The door inner piece (1) and the door outer sheet (2) are connected to each other by a laser-welded seam (7) produced by a laser beam directed in the gap between the mating surface (12) and the edge (13).

The present invention pertains to a method for production of a door for a motor vehicle, comprising at least one door inner piece and at least one door outer sheet, which are produced separately from each other and are then combined, and to a frameless door for a motor vehicle, preferably produced according to such a method.

With regard to a weight reduction producing doors for motor vehicles from lightweight construction materials, especially aluminum, and combining the inner and outer pieces by means of high-strength joining, especially laser welding, belongs to the state of the art. However, laser welding requires a high dimensional accuracy of the outer and inner pieces to be joined.

A door for a motor vehicle, whereby a single-piece door outer element is made of aluminum, which is reinforced on the inside by means of hollow supports that are also preferably made of aluminum, has become known from DE 35 01 239 A1. The outer piece and the hollow supports are detachably joined with the actual door inner sheet via joining elements.

Furthermore, joining the inner pieces of a door to an outer sheet by means of hemming has become known. In this case, a high dimensional accuracy of the pieces to be joined is likewise necessary, and, under the circumstances, additional measures must be taken to produce a strong bond.

The object of the present invention is to suggest a method for production of a door which is as light as possible with a high-strength joining between inner piece and outer sheet, whereby the design of the production technique may be more cost favorable, more flexible and simpler.

This object is accomplished as indicated in patent claim 1. The subclaims 2 to 11 contain additional meaningful measures. A frameless door produced preferably according to the method according to the present invention, which accomplishes the object of the present invention, is indicated in patent claim 12.

The method according to the present invention provides that a said door inner piece made entirely or partially from cast aluminum, and preferably designed as a single-piece aluminum die-casting is joined with a door outer sheet made of aluminum by means of laser welding. Hemming of the joint is omitted in this case. The edge of the outer sheet is folded only towards the door inner piece, and preferably by max. 90°, and brought into contact with the outer edge of the door inner piece. By the use of an especially single-piece door inner piece made of cast aluminum, the number of individual parts of a door is reduced and especially the joining technique is simplified. Cast aluminum makes it possible to produce complex shapes for the door inner piece, which is not possible, e.g., by means of reshaping the sheet, since aluminum can only be reshaped on a limited basis because of relatively low ductility. It is also important that a sealing of the bond that is usually necessary in hemming is not necessary in the method according to the present invention. Thus, the applications necessary for the sealing and the aftertreatment with heating are omitted. By means of laser welding according to the present invention, the pieces are joined without the action of force, and a change in shape of the door outer sheet—as is possible, e.g., in the frictional connection by hemming—is prevented.

The use of the single-piece door inner piece made of cast aluminum also saves additional joining techniques for optional reinforcements, since additional strengthenings of the component can easily be achieved by means of a corresponding cast ribbed structure. As a result, the crash stiffness of the frameless door can be specifically improved.

The present invention is explained in detail, e.g., based on the attached FIGS. 1 through 4.

FIG. 1 shows an overall view of a front door on a vehicle,

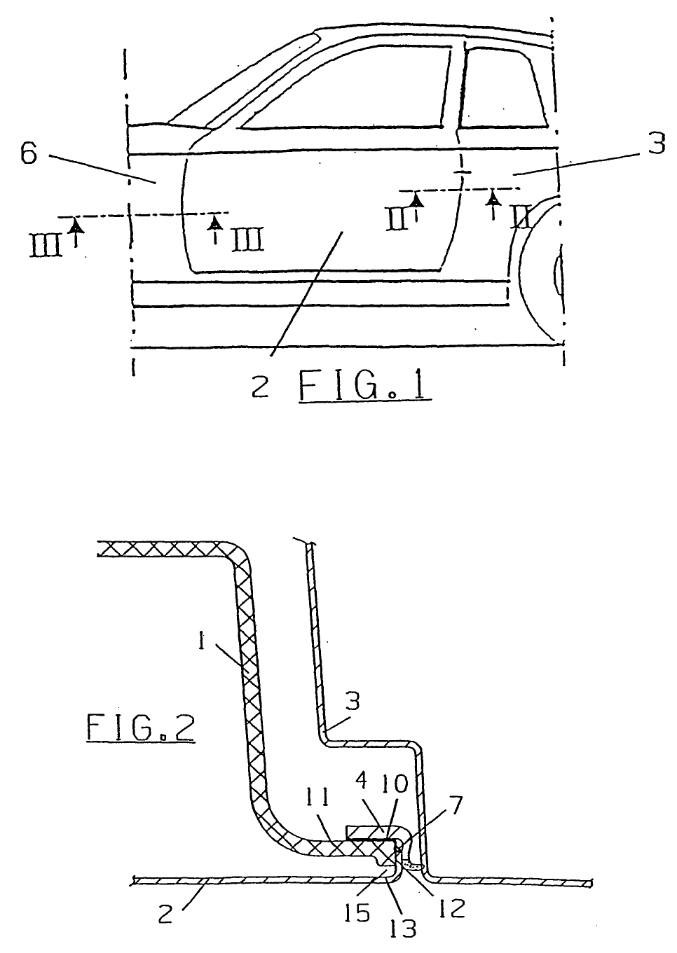

FIG. 2 shows a horizontal sectional view according to line II-II of FIG. 1 of the cutout of the bond according to the present invention between the door inner piece 1 and the door outer sheet 2 in the area of the side part 3 of the vehicle,

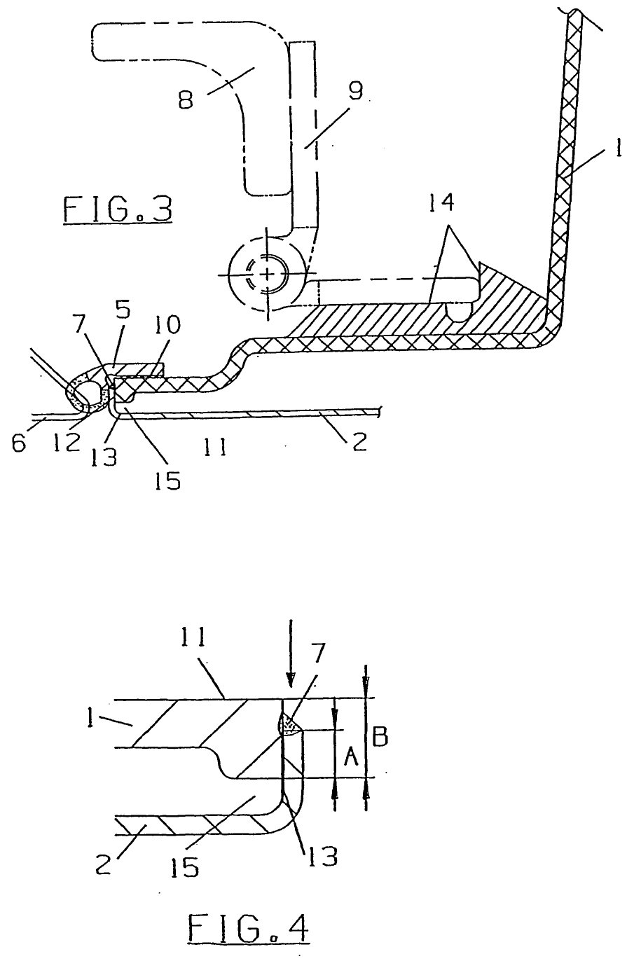

FIG. 3 shows a horizontal sectional view according to line III-III of FIG. 1 of the bond according to the present invention of the door inner piece 1 and the door outer sheet 2 in the area of the fastening of the door to a spar 8 by means of the hinge 9, and

FIG. 4 shows an enlarged view, compared to FIGS. 2 and 3, of the joining point between the door inner piece 1 and the door outer sheet 2.

The door inner piece 1, profiled corresponding to the needs, has a mating surface 12 on each of its outer edges 11, which [mating surface] can be machined corresponding to the needs for later laser welding. The edge 13 of the door outer sheet 2 folded inwards is brought into contact with the said mating surface 12. A laser-welded seam 7, designed as a fillet weld, is then produced by means of a laser beam directed in the gap between the contact surfaces. As is especially evident from FIG. 4, the width A of the contact of the edge 13 with the mating surface 12 is ca. half the size of the total width B of the mating surface of the inner piece 1. As a result of this, a minimum contact is always guaranteed even in case of tolerance differences. The gap 15 between the edge 13 of the outer sheet 2 and the edge 11 of the door inner piece 1 thus makes possible an adjustment corresponding to the needs.

FIGS. 2 and 3 additionally show joint sealings 4 and 5, known per se, which are, on the one hand, fastened on the inside of the outer edge 11 of the door inner piece 1 by means of a usual adhesive 10 and, on the other hand, come into contact either with the side part 3 or the front fender 6.

For the fastening of the door to the hinge 9, the door inner piece 1 preferably has machined mating surfaces 14 in order to likewise bond them [sic, “Sie” should be “sie” —Tr.Ed.] to the one leg of the hinge 9 by means of laser welding.

List of Reference Numbers

| | |
|---|---|
| 1 | Door inner piece (made of cast aluminum, single-piece) |
| 2 | Door outer sheet (made of aluminum) |
| 3 | Side part |
| 4 | Joint sealing |
| 5 | Joint sealing |
| 6 | Front fender |
| 7 | Laser-welded seam |
| 8 | Spar |
| 9 | Hinge |
| 10 | Adhesive for connecting 4 and 5 with 1 |
| 11 | Outer edge of 1 |
| 12 | Mating surface on 11 (machined) |
| 13 | Edge of 2 (adjacent to 12) |
| 14 | Mating surfaces on 1 (adhesive for fastening to 9) |
| 15 | Gap between 2 and 11 |
| A | Width of the contact of 13 with 12 |
| B | Width of 12 |

1. Method for production of a door for a motor vehicle, comprising at least one said door inner piece (1) and at least one said door outer sheet (2), which are produced separately from each other and are then combined into one unit, whereby
a) the said door inner piece (1) is entirely or partially made of cast aluminum,
b) the said door outer sheet (2) is made of aluminum,
c) the said edge (13) of the said door outer sheet (2) is folded towards the said door inner piece (1),
d) the said folded edge (13) of the said door outer sheet (2) is brought into contact with a said mating surface (12) of the said outer edge (11) of the said door inner piece (1), and
e) the said door inner piece (1) and the said door outer sheet (2) are connected to each other by a said laser-welded seam (7) produced by means of a laser beam directed in the gap between the said mating surface (12) and the said edge (13).

2. Method in accordance with claim 1, characterized in that the said door inner piece (1) is designed as a single-piece or multiple-piece cast aluminum piece.

3. Method in accordance with claims 1 or 2, characterized in that the said door inner piece (1) is produced as a cast aluminum piece [sic, “Anluminiumdruckgussteil” is a typo—Tr.Ed.].

4. Method in accordance with claims 1, 2 or 3, characterized in that the said door inner piece (1) is made of a weldable aluminum alloy with high ductility.

5. Method in accordance with one of the above claims, characterized in that the said door inner piece (1) contains the alloy AlMg 5 Si 1.2 Mn.

6. Method in accordance with claim 1, characterized in that the said door outer sheet (2) contains the alloy AlMg 0.4 Si 1.2 (Alu 6016).

7. Method in accordance with claim 1, characterized in that the said mating surfaces (12) of the said door inner piece (1) are machined as a prerequisite for the laser welding and for producing the necessary gap.

8. Method in accordance with claim 1, characterized in that the said mating surfaces (14) of the said door inner piece (1) are machined for the hinge contact, as a prerequisite for joining by means of laser welding.

9. Method in accordance with claim 1, characterized in that the said width A of the contact surface of the said edge (13) of the said door outer sheet (2) is ca. half the said width B of the said mating surface (12) of the said door inner piece (1).

10. Method in accordance with claim 1, characterized in that the said edge (13) of the said door outer sheet (2) is folded by at most 90° before the laser welding.

11. Method in accordance with claim 1, characterized in that the said laser-welded seam (7) is covered by a said profiled joint sealing (4, 5) adhered on the inside of the said door inner piece (1).

12. Frameless door for a motor vehicle, which is preferably produced according to a method in accordance with one of the above claims, comprising a preferably single-piece or multiple-piece door inner piece (1) made entire or partially of cast aluminum with a said outer edge (11) and said machined mating surfaces [sic, “Anbstimmflächen” is a typo—Tr.Ed.] (12), with which a said edge (13) of a said door outer sheet (2) made of aluminum, which edge is folded towards the said door inner piece (1), is connected by laser welding by means of a laser beam directed in the gap between the said edges (11, 13).
